(19) United States
(12) Patent Application Publication
(10) Pub. No.: US 2006/0277875 A1
(43) Pub. Date: Dec. 14, 2006

(54) Stackable air purifier system with expandable housing

(75) Inventor: Daniel E. Schuld, Inverness, IL (US)

Correspondence Address: Paul G. Juettner;GREER, BURNS & CRAIN, LTD., Suite 2500, 300 South Wacker Drive, Chicago, IL, 60606, US

(73) Assignee: RPS Products, Inc.

(21) Appl. No.: 11/147,528

(22) Filed: Jun. 8, 2005

(51) Int. Cl. B01D 46/00

(52) U.S. Cl. 55/484

(57) ABSTRACT

An air purifier includes a base, one or more filter units and a cover unit. The base has a housing, a blower, vents in the housing for the egress of air from the blower, a first channel providing ingress of air to the blower and a connector on the housing. One or more filter units attach to the base, each of which includes a filter unit housing, openings in the filter housing for ingress of air, a second channel providing air from the openings to the first channel and a filter media between the openings and the channel to filter the air. At opposing ends of the filter unit are connectors configured to matingly engage with the connector of an adjacent unit. The last filter unit mounted is engaged with a cover having a housing and another connector, wherein the connectors engage with a connector on an adjacent unit.

### FIELD OF THE INVENTION

This invention relates to an air purifier having an air cleaning capacity that is variable by the consumer. More specifically, the invention relates to an air cleaner having stackable filter units for easy replacement or addition of filters.

### BACKGROUND

There has been a growing interest in environmental conditions as the number of airborne pollutants increases. Increased use of technology and increasing population density are leading to more pollutants being produced in smaller areas. People are concerned about inhaling increased dust, smoke, bacteria, particulates, mold, pollen and chemical components such as SOₓ or NOₓ. Instances of asthma, allergies, respiratory infections and other symptoms increase as air quality decreases. An increase in indoor air pollution has led to increased demand for air cleaners, filters and purification units to provide cleaner air in their homes.

Small, portable air purifiers are available on the market for use in the home, office or for travel that are effective in removing particulate matter from the air. The size and portability of the units allows them to be moved from room to room, or from home to office, as the user's needs change. However, as the size of the room changes, the capacity of the air purifier may be insufficient to efficiently clean the volume of air in a larger room. Thus an air purifier that works extremely well in an office or bedroom may lack capacity to turn over the air in a large family room or conference room. Portability of an air purifier does not help in situations where increased capacity is needed to provide adequate filtration in a proposed location.

It is known to use modular filter segments for ease in changing filters of a manageable size or to provide a step increase or decrease in unit capacity. U.S. Pat. No. 4,629,482 describes a HEPA filter having stackable filter units. However, the physical size of the unit does not change because the housing is fixed. If fewer filter segments are used, there is no space saved. The air purifier may also become inefficient because of bypassing of the filter media. The capacity of the air purifier cannot be increased since the housing will not accommodate additional filter units.

Thus, there is a need in the art for an air cleaner or purifier having variable capacity whereby the housing expands and contracts to efficiently.

### SUMMARY OF THE INVENTION

The present invention relates to an improved air purifier of modular design. More specifically, the air purifier can be adapted to different size and capacity depending on the amount of air purification desired.

An air purifier assembly includes a base unit, one or more filter units and a cover unit. The base unit has a housing, a blower held within the base unit housing, vents in the base unit housing for the egress of air from the blower, a first channel providing ingress of air to the blower and a first connector on the base unit housing. Attachable to the base unit is one or more filter units, each of which includes a filter unit housing, openings in the filter unit housing for ingress of air, a second channel providing air from the openings to the first channel and a filter media between the openings and the channel to filter the air. At opposing ends of the filter unit are first and connectors, where the second connecter is configured to matingly engage with the first connector of an adjacent unit. The last filter unit to be mounted is engaged with a cover unit having a cover housing and another of the second connectors, wherein the first connector on the base unit engages the second connector on the at least one filter unit and the another of the first connectors on the at least one filter unit connects to the another of the second connectors on the cover housing.

Preferred embodiments of the air purifier include arrangement of the openings in a decorative pattern for a pleasing appearance. In more preferred embodiments, the decorative pattern is continued on at least one of the cover unit and the base unit. It is also preferred that the first channel vertically align with the second channel.

The air purifier of modular design provides an ability to adapt the size of the housing, and therefore the air cleaning capacity of the unit, that is not shown in the prior art. Each of the base unit, cover unit and filter unit has its own housing. If additional filter units are needed to meet the air cleaning capacity, each of them supplies their own housing portion, allowing the air purifier to grow in size and still have a uniform, pleasing appearance. The air purifier can also be reduced in capacity by removal of one or more filter units, resulting in a commensurate reduction in the physical size of the purifier.

### BRIEF DESCRIPTION OF THE DRAWINGS

FIG. 1 is an elevated perspective view of an air purifier of the present invention having a single filter unit;

FIG. 2 is an elevated perspective view of the air purifier of FIG. 1 with a second filter unit;

FIG. 3 is an elevated perspective view of the base unit;

FIG. 4 is a side planar view of the base unit of FIG. 3 with a portion of the housing cut away;

FIG. 5 is a perspective view of a filter unit with the door open; and

FIG. 6 is an exploded view of the air purifier of FIG. 1.

### DETAILED DESCRIPTION OF THE INVENTION

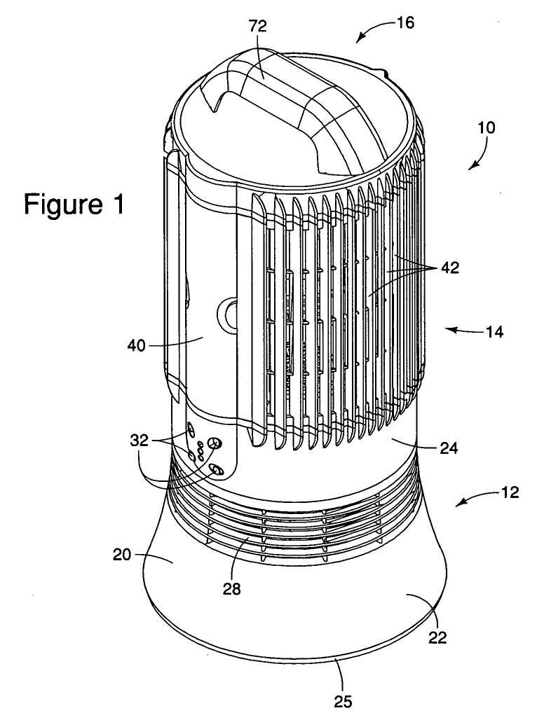

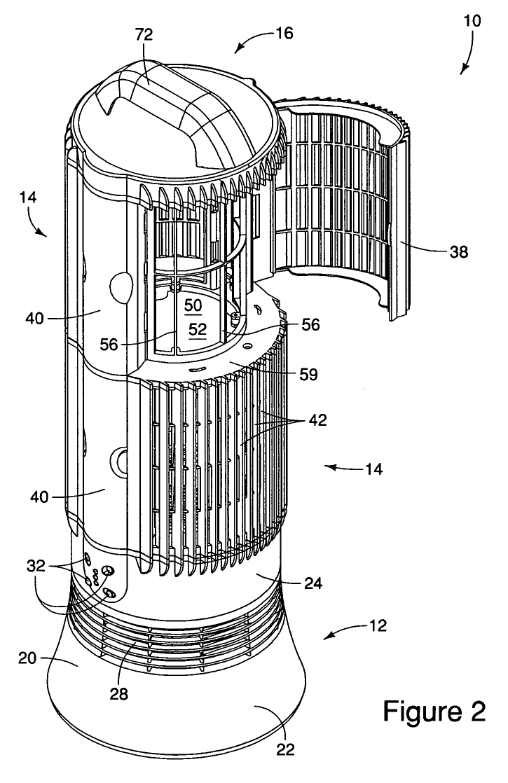

Referring to FIGS. 1 and 2, an air purifier, generally designated 10, is made up of a base unit, generally 12, at least one stackable filter unit, generally 14, and a cover unit, generally 16. Air cleaning capacity of the air purifier 10 is expanded or reduced by varying the number of stackable filter units 14.

The base unit 12 has a base unit housing 20 that is configured to rest on a substrate and to support the air purifier 10. A bottom portion 22 of the base unit housing 20 that is closest to the substrate preferably has a larger cross-section than a top portion 24 of the base unit housing 20 to provide stability to the air purifier 10 so that it is not easily toppled over. However, it is contemplated that other means also be used to stabilize the air purifier 10, including the use of feet or legs (not shown) or a stabilizing ring 25 to hold the purifier off the substrate and to extend outwardly to increase the effective cross-section of the base unit 12.

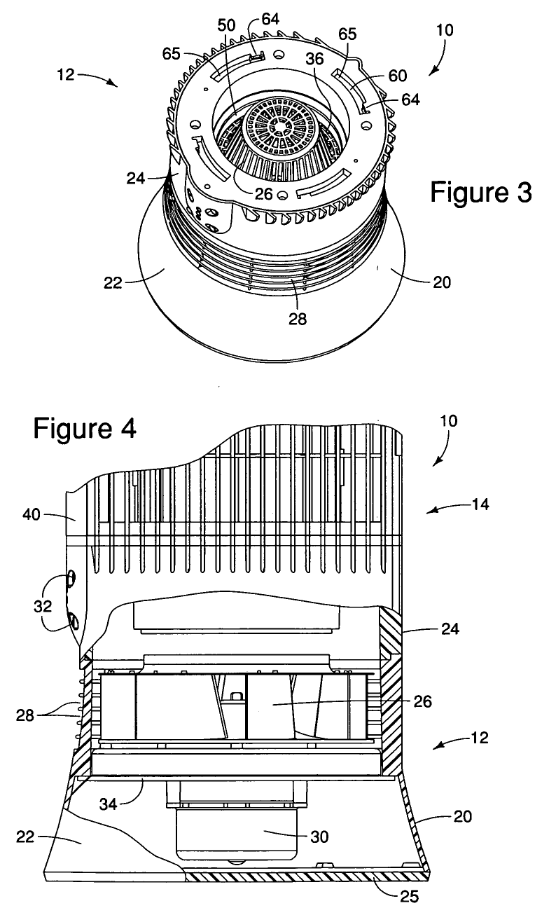

Electrical components of the air purifier 10 are contained within the base unit housing 20 and are best seen in FIGS. 3 and 4. A blower 26 is positioned within the base unit housing 20 to draw air from the interior of the purifier 10 and exhaust it through vents 28 in the base unit housing 20. Any blower 26 of appropriate size and power for this type of application is useful in the air purifier 10. Preferably, the blower 26 has multiple speeds for additional versatility. Use of a two or three speed blower 26 is preferred. The base unit 12 also contains the power connections (not shown) appropriate to operate a motor 30 for the blower 26 and controls 32 necessary to turn the unit on and off, or to change speeds on a multi-speed blower. The blower motor 30 is held in place by the motor mount 34.

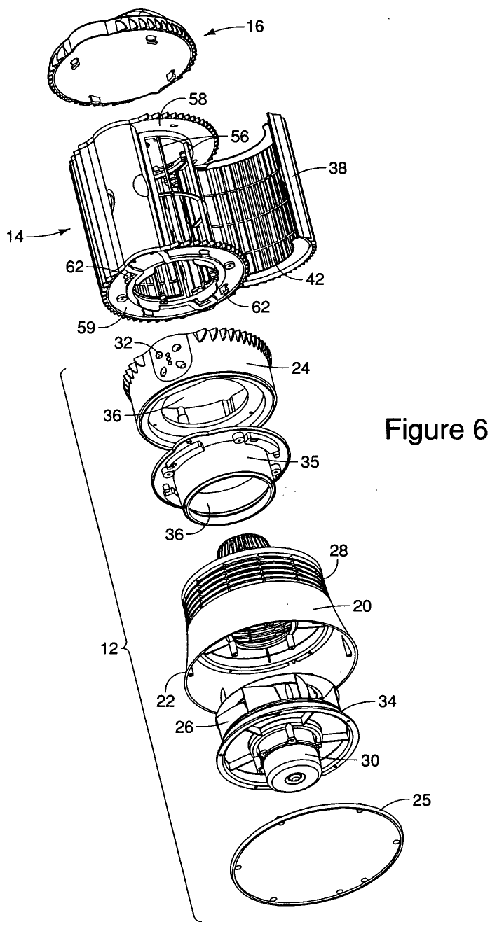

The vents 28 in the base unit housing 20 are for the egress of air from the blower 26. Any size and shape of vent 28 is suitable as long as they provide a suitable rate of air flow so that air drawn into the filter unit 14 by the blower 26 is allowed to exit via the vents 28. The filter unit 14, the blower 26 and the vents 28 cooperate to produce sufficient air flow to meet the rated capacity of the air purifier unit 10. Air enters the base unit housing 20 through the top portion 24 and a venturi 35 (FIG. 6) from the filter unit 14 stacked above it through a first channel 36 in the base unit housing 20. When connected to the filter unit 14, suction from the blower 26 draws air downward from the filter unit into the base unit 12.

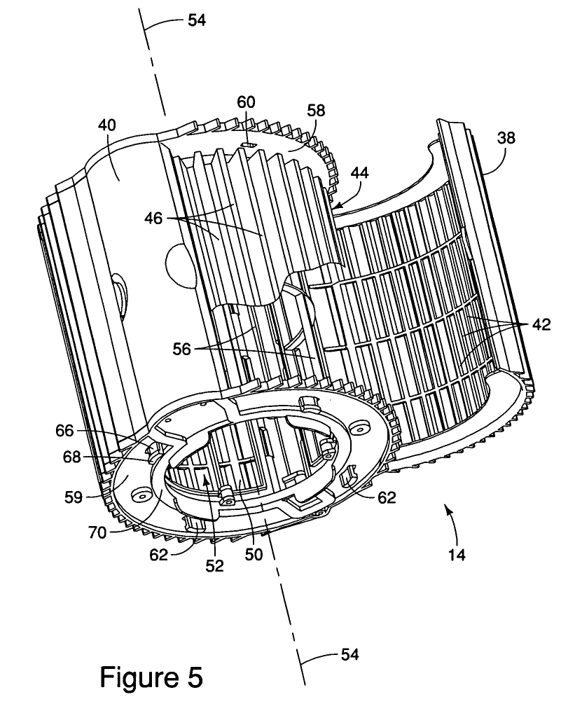

Referring to FIG. 5, there is at least one filter unit 14 in each air purifier 10. Adding an additional filter unit 14 to the air purifier unit 10 increases its capacity, while the purifier can be made suitable for a smaller space by decreasing the number of filter units. Each of the filter units 14 includes a filter unit housing 40 that protects and supports the filter unit and also has an aesthetically pleasing exterior. Since the air filter units 14 do not reside within another housing, the exterior of the filter unit housing 40 is visible to those in the environment. Preferred materials for the filter unit housing 40 include plastics, metals, metal foils, heavy paper or cardboard, particularly those coated to provide a decorative finish. Optionally, the filter unit 14 has one or more doors 38 for access to the interior of the air purifier 10.

The filter unit housing 40 includes openings 42 to allow for ingress of air into the air purifier 10, preferably arranged in a decorative pattern to provide an aesthetically pleasing appearance. Size and number of the openings 42 should give sufficient open area that the blower 26 is able to draw sufficient air into the air purifier 10 to provide the degree of air cleaning desired. Optionally, a decorative pattern used for the openings 42 is shown on at least one of the cover unit 16 and/or the base unit 12 to give the air purifier a coordinated appearance. For example, if the openings 42 were hexagonally shaped, the decorative pattern could include printed, stamped or embossed hexagons on the base unit housing 20 or the cover unit 16. However, there should be no holes other than the openings 42 on the suction side of the blower 26 that would allow air to bypass the filter unit 14.

Inside the filter unit 14 is a filter media 44 that traps particulate material, removing it from the flowing air. Many types of the filter media 44 are useful, depending primarily on the size of particulates to be removed. Commonly used filter media 44 removes 80-85% of the particles of one micron or larger. More expensive HEPA filter media 44 filters at least 99.97% of airborne particulates of 0.3 microns or larger. Choice of the filter media 44 is determined by the desired level of filtration and the cost. Filter units 14 can be made in a variety of filter media 44, giving the consumer the choice of whether to spend more money for a more efficient filter media. Preferred filter media include HEPA filters. The filter media 44 is optionally arranged in pleats 46 to increase the amount of surface area available to trap particulates.

Turning to FIG. 2, suction to draw air in through the openings 42 of the filter unit housing 40 and the filter media 44 is provided via a conduit 50 that runs down the inside of the filter units 14 to the blower 26. The conduit 50 is made up of the first channel 36 in the base unit 12 and a second channel 52 in each of the filter units 14 that are sufficiently aligned that the blower 26 suction causes circulation of air in through the openings 42 and filter media 44, then through the conduit 50 to the blower 26 for exhaustion through the vents 28 in the base unit 12. Preferably the channel 50 is substantially aligned with a vertical axis 54 of the air purifier 10 as it is oriented in FIG. 1. More preferably, the axis 54 is approximately centrally aligned within the interior of the air purifier 10.

Any method may be used to support the filter media 44 within the filter unit 14. Preferably, one or more of the filter supports 56 are positioned inside the door 38 between a filter top 58 and a filter bottom 59. The supports 56 prevent the filter media 44 from collapsing into the conduit 50 and allowing at least a portion of the air from bypassing the filter media. The filter media 44 is optionally attached to the filter support 56 or it is optionally cut so that it is held in place by friction between the filter media and the filter top 58 and filter bottom 59.

The base unit 12, filter units 14 and cover unit 16 connect to each other by means of a first connector 60 and a second connecter 62 configured to matingly engage with each other. Any type of first and second connectors 60, 62 can be used. Preferably, the first connector 60 and the second connector 62 attach to each other without the need for additional parts or tools or with a quick-connect mount. Preferably, the first connector 60 is a slot having a narrow portion 64 and a wide portion 65 (FIG. 3). The second connector 62 is preferably an “L” shaped tab having a leg 66 with a foot 68 (FIG. 5) at one end and being attached to the appropriate unit, e.g. filter unit 14 or cover unit 16. Both of the connectors are sized and shaped so that the foot 68 fits into the wide portion 65 of the slot 60, but locks when the tab 62 is moved so that the foot is in the narrow portion 64 of the slot. In the preferred embodiment, a plurality of connectors 60, 62 are aligned so that all of the tabs 62 fit within the slots 60 and are locked essentially simultaneously. Where the purifier 10 is cylindrical, as shown, multiple connectors are engaged at once by aligning the tab 62 in the slot 60 and rotating one of the units 12, 14, 16 about the longitudinal axis 54.

An important feature of assembling the air purifier is that air is not allowed to enter the air purifier 10 by bypassing the filter media 44, decreasing the efficiency of the air purifier. Any method of preventing bypassing may be used, including utilizing a seal 70 to stop air from entering between the base unit 12 and filter unit 14, the filter unit and the cover unit 16 or between two filter units, or by placing additional filter media 44 so that air that enters between component units is filtered. Preferably, when the first and second air connectors 60,62 are engaged, the seal 70 is formed, with or without the addition of a separate seal or gasket. If either of the adjacent units 12, 14, 16 include made of a flexible or malleable material, then an airtight seal could be formed when the connectors 60, 62 are connected to each other. In other cases, the seal 70 is created by a rim 71 at least one of the base unit 12, the filter unit 14 and the cover unit 16 that seals with the housing or a corresponding rim on an adjacent unit.

Referring to FIG. 6, when the filter units 14 are stacked vertically, the first and second connectors 60, 62 are alternated so that adjacent units connect to each other. The base unit 12 has a top portion 24 has the first connector 60 that connects to the second connector 62 on one end of the filter unit 14 and with the cover unit 16. On the filter unit 14, the second connector 62 is on the end of the filter unit opposing the first connector 60. When assembled, the base unit 12 of the air purifier 10 has the first connector 60 connected to the second connector 62 of the filter unit 14. The other end of the filter unit 14 has the first connector 60 that is connected to the second connector 62 of the next filter unit 14, if another filter unit is present.

When the desired number of filter units 14 is in place, the cover unit 16, which includes a second connector 62, is attached to the top of the upper most filter unit 14. In addition to the second connector 62, the cover unit 16 also includes a cover housing 71 and an optional carrying handle 72. In addition to improving portability, the handle 72 preferably allows the user to mount the cover to the top filter unit with one hand, engaging the first and second connectors.

In use, the air purifier 10 is prepared for use by installing the appropriate number of filter units 14 prior to use. The number of filter units 14 to be used is determined by the capacity of each filter unit 14 and the size of the air space being cleaned. At least one of the filter units 14 is installed on the base unit by engaging the first connector 60 of the base unit with the second connector of the filter unit. If additional filter units 14 are to be used, the second connector 62 of the next filter unit is engaged 14 with the first connector 60 with the filter unit previously installed. This step is repeated until the air purifier 10 is an appropriate size to accommodate the room in which it is to be used. When all filter units 14 are installed, the unit 16 cover is mounted on to the upper most filter unit 14 be engaging the first connector 60 of the upper most filter unit 14 with the second connector 62 of the cover.

Once the air purifier 10 has been assembled in an appropriate configuration, it should be placed in suitable location, connected to an electrical outlet and turned on. If one or more of the filter units 14 becomes damaged or becomes inefficient because the amount of particulate matter collected has begun to block the pores of the filter media, the air purifier 10 can be disassembled by reversing the steps listed above. The air purifier 10 is then reassembled using new or different filter units 14 as appropriate. If the air purifier 10 is moved to another room, the capacity of the air purifier 10 is adjusted by removing or adding filter units 14, as needed.

While specific embodiments of the air purifier of the present invention have been shown and described, it will be appreciated by those skilled in the art that changes and modifications may be made thereto, such as reversing the direction of air flow by changing the direction of the blower, without departing from the invention in its broader aspects and as set forth in the following claims.

What is claimed is:

1. An air purifier assembly comprising:
a base unit comprising a housing, a blower held within the base unit housing, vents in said base unit housing for the egress of air from said blower, a first channel providing ingress of air to said blower and a first connector on said base unit housing;
at least one filter unit comprising a filter unit housing, openings in said filter unit housing for ingress of air, a second channel providing air from said openings to said first channel, filter media between said openings and said channel to filter the air, another of said first connectors and a second connecter configured to matingly engage with said first connector of an adjacent filter or base unit; and
a cover unit comprising a cover housing and another of said second connectors, wherein said first connector on said base unit engages said second connector on said at least one filter unit and said another of said first connectors on said at least one filter unit connects to said another of said second connectors on said cover housing.

2. The air purifier of claim 1 wherein said at least one filter unit comprises a first filter unit and a second filter unit and wherein said first connector of said base unit matingly engages with said second connector of said first filter unit, said first connector of said first filter unit matingly engages with aid second connector of said second filter unit, and said first connector of said second filter unit matingly connects with aid second connector of said cover unit.

3. The purifier of claim 1 wherein said second channel vertically aligns with said first channel.

4. The air purifier of claim 1 wherein said base unit further comprises a control panel.

5. The air purifier of claim 1 wherein said cover further comprises a handle.

6. The air purifier of claim 1 wherein said blower is a multi-speed blower.

7. The air purifier of claim 1 wherein said openings are arranged in a decorative pattern.

8. The air purifier of claim 1 wherein said filter media is a HEPA filter.

9. The air purifier of claim 1 wherein said first connector and said second connector attach to each other without the need for tools.

10. The air purifier of claim 3 wherein said first channel and said second channel are substantially aligned with a vertical axis of the air purifier.

11. The air purifier of claim 1 wherein said filter media is pleated.
